(19) United States
(12) Patent Application Publication
(10) Pub. No.: US 2026/0171428 A1
(43) Pub. Date: Jun. 18, 2026

(54) SOLID OXIDE CELL

(71) Applicant: SAMSUNG ELECTRO-MECHANICS CO., LTD., Suwon-si (KR)

(72) Inventors: Su Beom PARK, Suwon-si (KR); A Reum JUN, Suwon-si (KR); Jae Seok YI, Suwon-si (KR); Sung Kwon AN, Suwon-si (KR); Yoon A JANG, Suwon-si (KR); Bon Seok KOO, Suwon-si (KR)

(73) Assignee: SAMSUNG ELECTRO-MECHANICS CO., LTD., Suwon-si (KR)

(21) Appl. No.: 19/414,569

(22) Filed: Dec. 10, 2025

(30) Foreign Application Priority Data
Dec. 13, 2024 (KR) 10-2024-0185928

(51) Int. Cl. H01M 4/86; C25B 9/19; C25B 11/031; C25B 13/07; H01M 8/12; H01M 8/1213; H01M 8/1226

(52) U.S. Cl. CPC H01M 4/8605; C25B 9/19; C25B 11/031; C25B 13/07; H01M 8/1213; H01M 8/1226; H01M 2004/8684; H01M 2008/1293

(57) ABSTRACT

A solid oxide cell includes a fuel electrode, an air electrode, and an electrolyte disposed between the fuel electrode and the air electrode, in which the fuel electrode includes a plurality of first pores having a bowl shape and second pores disposed within the bowl.

### CROSS-REFERENCE TO RELATED APPLICATION(S)

This patent document claims the priority and benefits of Korean Patent Application No. 10-2024-0185928 filed on Dec. 13, 2024, the disclosure of which is incorporated herein by reference in its entirety.

### TECHNICAL FIELD

The present disclosure relates to a solid oxide cell.

A solid oxide fuel cell (SOFC) and a solid oxide electrolysis cell (SOEC) include a cell composed of an air electrode, a fuel electrode, and a solid electrolyte having oxygen ion conductivity, in which the cell may be referred to as a solid oxide cell. The solid oxide cell produces electrical energy through an electrochemical reaction or produces hydrogen by electrolyzing water through a reverse reaction of the solid oxide fuel cell. Compared to other types of fuel cells or water electrolysis cells, such as a phosphoric acid fuel cell (PAFC), an alkaline fuel cell (AFC), a polymer electrolyte fuel cell (PEMFC), and a direct methanol fuel cell (DMFC), the solid oxide cell has low overvoltage and low irreversible loss due to having low activation polarization, leading to high efficiency. In addition, the solid oxide cell has a wide range of fuel options as it may use not only hydrogen but also carbon or hydrocarbon-based fuels, and has the advantage of not requiring expensive precious metals as electrode catalysts because the reaction rate at the electrode is high.

The solid oxide cell generally has a structure in which an electrolyte is disposed between electrode layers, and the reaction that allows the solid oxide cell to function as a battery occurs in the electrode layers. In order for the reaction to occur effectively in the electrode layers, a fluid should be able to easily pass through. To this end, a technology for forming pores in the electrode layers, or the like is known.

### SUMMARY

An aspect of the present disclosure is to implement a highly reactive solid oxide cell by providing a smooth fluid flow.

According to some aspects of the present disclosure, a solid oxide cell may include a fuel electrode, an air electrode, and an electrolyte disposed between the fuel electrode and the air electrode, in which the fuel electrode may include a plurality of first pores having a bowl shape and second pores disposed within the bowl.

In a cross section of the fuel electrode, a length of the first pore may be irregular with respect to a central axis direction of the bowl.

The second pore may have a spherical shape.

The first pore and the second pore may be connected to each other.

At least some of the plurality of first pores may be connected to each other.

The fuel electrode may further include a third pore disposed outside of the bowl of the first pore.

At least some of the plurality of first pores may be connected to each other by the third pore.

The fuel electrode may include a fuel electrode support and a fuel electrode functional layer disposed between the electrolyte and the fuel electrode support, and the fuel electrode support may include the first pore and the second pore.

A partial region of the first pore may be located within the bowl of another adjacent first pore.

A partial region of the first pore located within the bowl may be connected to the second pore.

A solid oxide cell may include a fuel electrode, an air electrode, and an electrolyte disposed between the fuel electrode and the air electrode, in which the fuel electrode may include a plurality of first pores having a bowl shape, and at least two of the plurality of first pores may have different shapes.

In one cross section of the fuel electrode, a length of the first pore may be irregular with respect to a central axis direction of the bowl.

The fuel electrode may further include a second pore in a form accommodated within the bowl.

The first pore and the second pore may be connected to each other.

At least some of the plurality of first pores may be connected to each other.

A partial region of the first pore may be located within the bowl of another adjacent first pore.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is an exploded perspective view schematically illustrating a solid oxide cell according to an example embodiment of the present disclosure;

FIG. 2 is a cross-sectional view schematically illustrating one region of the solid oxide cell;

FIG. 3 is an enlarged view of one region of the fuel electrode;

FIG. 4 is a perspective view schematically illustrating a bowl-shaped pore within the fuel electrode;

FIG. 5 is a diagram illustrating a process of forming pores within the fuel electrode;

FIG. 6 is an enlarged view of one region of an electrolyte;

FIG. 7 is an enlarged view of one region of an air electrode;

FIG. 8 is a diagram illustrating an arrangement of pores within the fuel electrode; and

FIG. 9 is a diagram illustrating the arrangement of the pores within the fuel electrode.

### DETAILED DESCRIPTION

Hereinafter, example embodiments will be described in detail with reference to the accompanying drawings. However, example embodiments may be modified in various other forms, and the scope of the present disclosure is not limited to example embodiments to be described below. Further, example embodiments are provided in order to more completely explain the present disclosure to those skilled in the art. In the drawings, the shapes and dimensions may be exaggerated for clarity, and the same reference numerals will be used throughout to designate the same or like components.

In order to clearly describe the present disclosure in the drawings, parts that are not related to the description are omitted, the thickness is enlarged to clearly express various layers and areas, and components with the same function within the scope of the same idea are described using the same reference numerals. Furthermore, throughout the present specification, unless explicitly described to the contrary, “comprising” any components will be understood to imply the inclusion of other elements rather than the exclusion of any other elements.

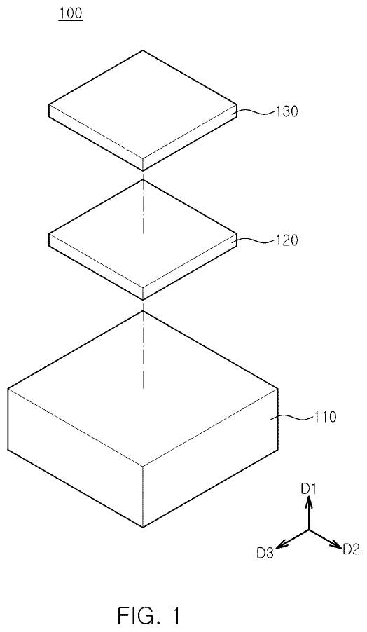

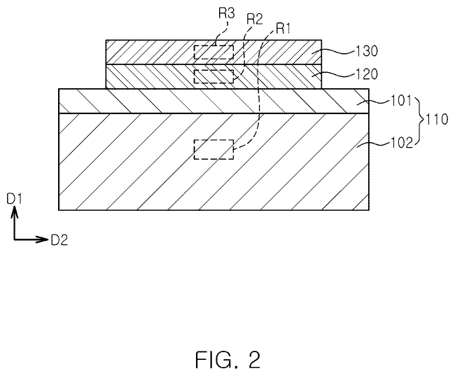

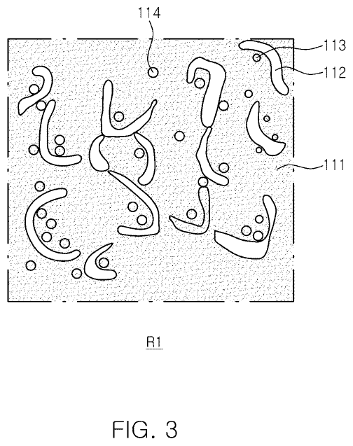

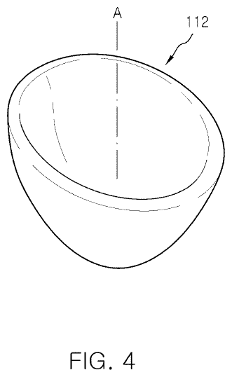

FIG. 1 is an exploded perspective view schematically illustrating a solid oxide cell according to an example embodiment of the present disclosure. FIG. 2 is a cross-sectional view schematically illustrating one region of the solid oxide cell. FIG. 3 is an enlarged view of one region of the fuel electrode, and FIG. 4 is a perspective view schematically illustrating a bowl-shaped pore within the fuel electrode.

First, referring to FIGS. 1 through 3, a solid oxide cell 100 according to some example embodiments of the present disclosure may include a fuel electrode 110, an air electrode 130, and an electrolyte 120 disposed between the fuel electrode 110 and the air electrode 130 as main components. Here, the fuel electrode 110 may include a plurality of first pores 112 in a bowl shape and second pores 113 disposed within the bowl, and the bowl shape may be defined as a bowl having a concave shape with an open top like a bowl that may accommodate things or a shape similar to the bowl. In addition, as another major feature of the present example embodiments, the plurality of first pores 112 in the bowl shape may be implemented in an irregular shape, and specifically, at least two first pores among the plurality of first pores 112 have different bowl shapes from each other. When the first pores 112 in the bowl shape may exist in the fuel electrode 110, it may be easy to obtain a connection structure between pores, and accordingly, the flow of fluid in the fuel electrode 110 may be made smooth. Accordingly, the reactivity in the solid oxide cell 100 may be improved, and in particular, when the solid oxide cell 100 is used as a solid oxide electrolysis cell (SOEC), it may contribute to the improvement of characteristics by making the flow of water vapor smooth.

The solid oxide cell 100 may be used as both a fuel cell and a water electrolysis cell, and in the case of the water electrolysis cell mode, a reaction opposite to that in the case of the fuel cell will occur at the fuel electrode 110 and air electrode 130 of the solid oxide cell 120. Specifically, when the solid oxide cell 100 is a fuel cell, for example, water generation or an oxidation reaction of a carbon compound due to the oxidation of hydrogen may occur at the fuel electrode 110, and an oxygen ion generation reaction due to the decomposition of oxygen may occur at the air electrode 130. When the solid oxide cell 100 is the water electrolysis cell, a reaction opposite thereto may occur, and for example, hydrogen gas may be generated at the fuel electrode 110 due to the reduction reaction of water, and oxygen may be generated at the air electrode 130. In addition, as another example, in the case of the fuel cell, a decomposition reaction (hydrogen ion generation) of hydrogen may occur at the fuel electrode 110, and oxygen and hydrogen ions may combine at the air electrode 130 to generate water. In the case of the water electrolysis cell, a decomposition reaction (hydrogen and oxygen ion generation) of water may occur at the fuel electrode 110, and oxygen may be generated at the air electrode 130. In addition, ions may move to the fuel electrode 110 or the air electrode 130 in the electrolyte 120.

Materials constituting the fuel electrode 110, the electrolyte 120, and the air electrode 130 will be described in detail. First, referring to FIG. 3, the fuel electrode 110 may include an electrode body 111, and the electrode body 111 may include an electronic conductor and an ion conductor. The electronic conductor and the ion conductor may be a sintered body of particles. The electronic conductor may perform an electrically conductive function, a catalytic function, etc., and may include, for example, metals such as Ni, Co, and Cu, a lanthanum chromite (La₁₋ₓSrₓCrO₃, where 0≤x<1) material, or the like. In addition, the ion conductor may include at least one selected from the group consisting of an yttria-stabilized zirconia (YSZ) material, a ceria (CeO₂) material, a bismuth oxide (Bi₂O₃) material, and a lanthanum gallate (LaGaO₃) material, etc.

The fuel electrode 110 may have pores that may serve as passages for fluids, and specifically, may include a plurality of first pores 112 and second pores 113 arranged within the first pores 112. Here, the fluid may include a gas and a liquid. The plurality of first pores 112 may have a bowl shape that may accommodate the second pores 113. That is, as in the form illustrated in FIG. 4, the bowl structure of the plurality of first pores 112 may correspond to a bowl that may accommodate the second pores 113 and a shape similar to the bowl. The first pore 112 may be an empty space within the fuel electrode 110, but in FIG. 4, the space surrounded by the electrode body 111 of the fuel electrode 110 is represented as the shape of the first pore 112. In the past, it was common to form a spherical pore within the fuel electrode 110, but in this case, there is a limit to the formation of the connection structure between the spherical pores, and when the size of the pore is increased to create the connection structure, the structural stability of the fuel electrode 110 may be reduced. In the case of having the bowl shape as in the present example embodiments, since it is easy to create the connection structure by the plurality of first pores 112, it may be advantageous in terms of the flowability of the fluid within the fuel electrode 110. Therefore, at least some of the plurality of first pores 112 may be connected to each other.

Rather than all of the plurality of first pores (112) having the same shape, some degree of shape irregularity in at least some of the pores may be preferable in terms of pore connectivity. Considering this, at least two of the plurality of first pores 112 within the fuel electrode 110 may have different bowl shapes from each other. In addition to the plurality of first pores 112 having different shapes from each other, the shapes of the first pores 112 themselves may also be irregular. That is, although FIG. 4 is a schematic diagram for describing the bowl structure of the first pore 112 and is expressed in a shape similar to a lens, in reality, at least some of the first pores 112 may have irregular shapes while basically maintaining the bowl structure. As a specific example, in one cross section of the fuel electrode 110, the length of the first pore 112 may be irregular with respect to a central axis A direction of the bowl formed by the first pore 112. This irregular shape of the first pore 112 may be obtained in the process of removing the pore forming agent during the firing of the fuel electrode 110, and as described above, corresponds to a shape suitable for improving the connectivity between pores. Here, when the first pore 112 is a place where the pore forming agent has escaped, the length of the first pore 112 may be several micrometers.

The second pore 113 is disposed in the bowl of the first pore 112, and by employing the second pore 113, porosity (about 40% to 50%) of the fuel electrode 110 may be improved without lowering the structural stability of the fuel electrode 110. In this case, the second pore 113 may have a spherical shape. In addition, the first pore 112 and the second pore 113 may be connected to each other, and thus the connectivity between pores may be secured.

As a structure for further increasing the porosity, as in the form illustrated in FIG. 3, the fuel electrode 110 may further include a third pore 114 disposed outside of the bowl of the first pore 112. The third pore 114 may have a spherical shape, similar to the second pore 113. When the third pore 114 is provided, at least some of the plurality of first pores 112 may be connected to each other by the third pore 114.

In the case of the solid oxide cell 100 according to the present example embodiments, the electrolyte 120 and the air electrode 130 may be a fuel electrode-supported structure supported by the fuel electrode 110. In the case of such a fuel electrode-supported solid oxide cell 100, since the thickness of the electrolyte 120 is relatively thin, the resistance to ion movement may be reduced, so that the output density may be improved. That is, as in the form illustrated in FIG. 2, the fuel electrode 110 may include a fuel electrode support 102 and a fuel electrode functional layer 101 disposed between the electrolyte 120 and the fuel electrode support 102. Here, the fuel electrode support 102 may increase the porosity and the connectivity between the pores to facilitate the fluid flow, and the fuel electrode support 102 may include the first pore 112 and the second pore 113 of the above-described structure.

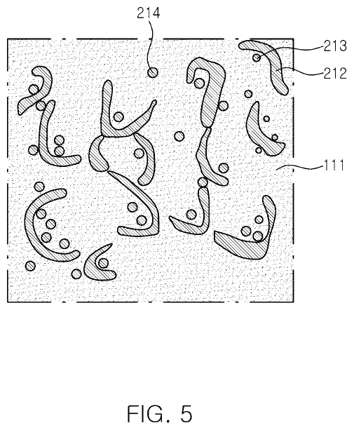

Meanwhile, referring to FIG. 5, the above-described pores 112, 113, and 114 in the fuel electrode 110 may be formed using pore forming agents 212, 213, and 214 that may be removed at a sintering temperature of the fuel electrode 110. For example, the pore forming agents 212, 213, and 214 may be polymethyl methacrylate (PMMA) particles, and in addition, particles including materials such as graphite, carbon black, polystyrene, and polyvinyl alcohol may be used. In FIG. 5, the pore forming agents 212, 213, and 214 are expressed as having the same shape as the pores 112, 113, and 114, but during the sintering process of the fuel electrode 110, the pores 112, 113, and 114 may be transformed into a different shape from the pore forming agents 212, 213, and 214.

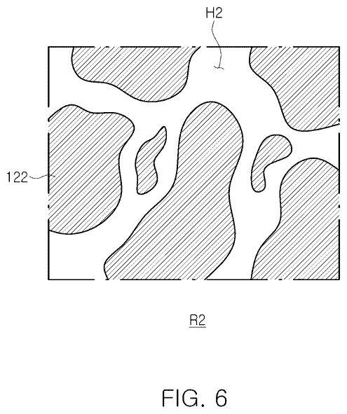

Other components of the solid oxide cell 100 are described. Referring to FIG. 6, the electrolyte 120 may be a sintered body of particles. The electrolyte 120 may be a porous body including pores H2, through which gas, fluid, etc., may pass. The electrolyte 120 may include an ion conductor 122, and an example of a material constituting the ion conductor 122 may include stabilized zirconia. Specifically, the ion conductor 122 may include at least one selected from the group consisting of smaydia-stabilized zirconia (SSZ), yttria-stabilized zirconia (YSZ), smaydia-ceria-stabilized zirconia (SCSZ), smaydia-ceria-yttria-stabilized zirconia (SCYSZ), and smaydia-ceria-ytterbia-stabilized zirconia (SCYbSZ), etc.

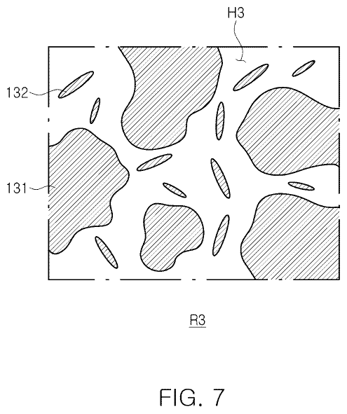

Referring to FIG. 7, the air electrode 130 may include an electronic conductor 131 and an ion conductor 132, which may be a sintered body of particles. In the air electrode 130, the electron conductor 131 may include an electrically conductive material, such as an electrically conductive perovskite material such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal such as Pt, may also be used. The ion conductor 132 may include materials such as yttria-stabilized zirconia-based (YSZ), ceria-based (CeO₂), bismuth oxide-based (Bi₂O₃), and lanthanum gallate-based (LaGaO₃). The air electrode 130 may include about 10 wt % to about 90 wt % of electronic conductor 131 and about 10 wt % to about 90 wt % of ion conductor 132, but according to the example embodiment, the air electrode 130 may not include the ion conductor 132. As in the illustrated form, the air electrode 130 may be a porous body including pores H3, through which a fluid may pass.

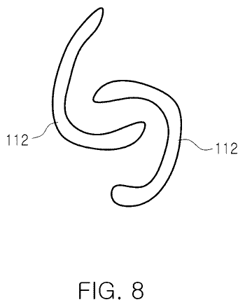

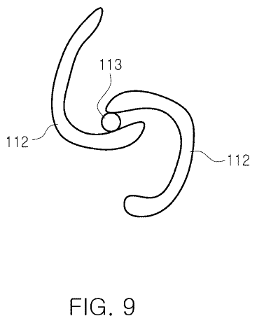

The arrangement of pores according to a modified example will be described with reference to FIGS. 8 and 9. First, FIG. 8 corresponds to an example in which the first pore 112 is disposed so as to further improve the porosity and the connectivity between the pores. Specifically, a partial region of the first pore 112 may be located within the bowl of another adjacent first pore 112. In addition, a partial region of another first pore 112 may also be positioned within the bowl of the first pore 112 so as to form an interlocking structure. In this case, as in the form illustrated in FIG. 9, a partial region of the first pore 112 positioned within the bowl of the first pore 112 may be connected to the second pore 113. The connection structure between adjacent first pores 112 may be obtained by the second pore 113.

According to the solid oxide cell according to some example embodiments of the present disclosure, it may be possible to improve the reactivity within the cell by making the fluid flow smooth. Therefore, it may be possible to improve the performance of the solid oxide cell when the solid oxide cell is used as the fuel cell or the water electrolysis cell.

While example embodiments have been shown and described above, it will be apparent to those skilled in the art that modifications and variations could be made without departing from the scope of the present invention as defined by the appended claims.

What is claimed is:

1. A solid oxide cell, comprising:
a fuel electrode;
an air electrode; and
an electrolyte disposed between the fuel electrode and the air electrode,
wherein the fuel electrode includes a plurality of first pores having a bowl shape and second pores disposed within the bowl.

2. The solid oxide cell according to claim 1, wherein, in one cross section of the fuel electrode, a length of the plurality of first pores is irregular with respect to a central axis direction of the bowl.

3. The solid oxide cell according to claim 1, wherein the second pores have a spherical shape.

4. The solid oxide cell according to claim 1, wherein at least one of the plurality of first pores and at least one of the second pores are connected to each other.

5. The solid oxide cell according to claim 1, wherein at least some of the plurality of first pores are connected to each other.

6. The solid oxide cell according to claim 1, wherein the fuel electrode further includes a third pore disposed outside of the bowl of the plurality of first pores.

7. The solid oxide cell according to claim 6, wherein at least two of the plurality of first pores are connected to each other by the third pore.

8. The solid oxide cell according to claim 1, wherein
the fuel electrode includes a fuel electrode support and a fuel electrode functional layer disposed between the electrolyte and the fuel electrode support, and
the fuel electrode support includes the first pore and the second pore.

9. The solid oxide cell according to claim 1, wherein a partial region of the plurality of first pores is located within the bowl of another adjacent at least one of the plurality of first pores.

10. The solid oxide cell according to claim 9, wherein a partial region of the plurality of first pores located within the bowl is connected to at least one of the second pores.

11. A solid oxide cell, comprising:
a fuel electrode;
an air electrode; and
an electrolyte disposed between the fuel electrode and the air electrode,
wherein the fuel electrode includes a plurality of first pores having a bowl shape, and
at least two of the plurality of first pores have different shapes.

12. The solid oxide cell according to claim 11, wherein, in one cross section of the fuel electrode, a length of the first pore is irregular with respect to a central axis direction of the bowl.

13. The solid oxide cell according to claim 11, wherein the fuel electrode further includes a second pore in a form accommodated within the bowl.

14. The solid oxide cell according to claim 13, wherein at least one of the plurality of first pores and at least one of the second pores are connected to each other.

15. The solid oxide cell according to claim 11, wherein at least two of the plurality of first pores are connected to each other.

16. The solid oxide cell according to claim 11, wherein a partial region of the plurality of first pores is located within the bowl of another adjacent at least one of the plurality of first pore.
